(19) United States
(12) Patent Application Publication
(10) Pub. No.: US 2026/0057808 A1
(43) Pub. Date: Feb. 26, 2026

(54) SAFETY LOCK SPRING CLIP, A METHOD FOR ATTACHING A LABEL TO A PRODUCT AND A USE OF A SAFETY LOCK SPRING CLIP

(71) Applicant: SUND BIRSTA AB, Sundsvall (SE)

(72) Inventors: Fabian ÖHLUND, MATFORS (SE); Björn HOLM, GNARP (SE)

(21) Appl. No.: 19/105,850

(22) PCT Filed: Aug. 25, 2023
(86) PCT No.: PCT/EP2023/073324

§ 371 Date: Feb. 24, 2025

(30) Foreign Application Priority Data
Aug. 25, 2022 (EP) 22192197.6

(51) Int. Cl. G09F 3/14; B65C 7/00; B65D 63/00

(52) U.S. Cl. CPC G09F 3/14; B65C 7/00; B65D 63/00; B65D 2203/02

(57) ABSTRACT

A safety lock spring clip is intended for attaching a label with at least one through hole to a product. The safety lock spring clip includes a base portion, intended for arrangement to a first through hole and/or a second through hole in the label, and at least one projecting leg extending from the base portion. The at least one projecting leg has an outer end intended to extend through the first through hole or the second through hole in the label when the spring clip is attached to the product and the label, the at least one projecting leg is arranged laterally relative the base portion. The leg has an extension tangentially projecting through the first through hole or the second through hole in the label such that the outer end is at a distance from the first through hole or the second through hole.

The invention relates to a safety lock spring clip, intended for attaching a label to a product. The invention also relates to a method for attaching a label to a product and a use of a safety lock spring clip.

### BACKGROUND

The invention is advantageously used as a safety lock spring clip, intended for attaching a label to a product such as products produced in metal and wood industry, for instance a wire coil or bundles of bars. Example of known safety lock spring clip are disclosed in US 2015/290812 A1, CN 112 404 297 A and KR 2012 0139307.

Metal wire, such as steel wire, and bars can be produced in a wide range of thickness dimensions. For distribution of the produced wire to an end costumer, wire can be arranged in ring laps into a coil in order to be easily handled and transported for delivery to the clients. With respect to bars, the bars are usually arranged in bundles by wrapping a wire or strap or steel band around the bundle for easy handling and transport. It is important that each individual bundle of bars or wire coil is marked properly such that the costumer can take part of essential information of the delivered wire or bar. For instance, the information can be presented via a barcode on the label. In the event of any questions about e.g. the quality of the wire or bar product, it is possible to trace for instance the exact batch, date and time for production, and other production data.

A common marking of products such as bundles of bars or individual wire coils are by arranging a label on each bundle of bars or wire coil. The label is attached to the wire, steel strap or the similar on the products, such as a wire coil or a bar, by a conventional key ring. The key ring is made of a thin wire provided with a few ring laps. Products, such as bars and wire coils, are often transported on an open bed of a lorry or truck, where they are subjected to wind and strong air flow. This may cause the key rings to start rotating at its attachment to the product. As a consequence, the label may come loose from the key ring or the key ring itself may disengage from the attachment to the product.

Consequently, there may be different criteria that need to be considered when designing an attachment of a label to a product, such as bars or wire coils. While it should be easy and not time-consuming to attach labels to such products, the attachment of the label should at the same time be secure to avoid that the label come loose from its attachment to the product.

There is a desire to improve a conventional key ring for attaching a label to a product.

There is also a desire to eliminate the risk for the label to come loose from a key ring or the similar when subjected to wind and strong air flow during transport and distribution.

A further desire is to provide an uncomplicated, effective and inexpensive attachment of a label to a product, such as bars or wire coils, that can be efficiently produced.

### SUMMARY

An object of the invention is to improve a conventional key ring for attaching a label to a product.

Another object of the invention is to find a secure attachment of a label to avoid that the label come loose from its attachment to a product, such as bars or wire coils.

A further object is to provide a label attachment that is easy to handle and not time-consuming when being attached to labels and to products, such as bars or wire coils.

Yet a further object is to eliminate the risk that a label will be detached from a key ring or the similar when subjected to wind and strong air flow during transport and distribution.

Yet another object is to provide an uncomplicated, effective and inexpensive attachment of a label to a product, such as bars or wire coils, that can be efficiently produced.

The objects are achieved by a spring clip according to claim 1. Thus, the objects are achieved by a safety lock spring clip, intended for attaching a label with at least one through hole to a product, such as a wire coil or bundles of bars. The spring clip comprising a base portion, intended for arrangement to a first through hole and/or a second through hole in the label, and at least one projecting leg extending from the base portion. The at least one projecting leg has an outer end intended to extend through said first through hole or said second through hole in the label when the spring clip is attached to the product and the label. The at least one projecting leg is arranged laterally relative the base portion, wherein the leg has an extension tangentially (T) projecting through the first through hole (20) or the second through hole (22) in the label (14) such that the outer end (10A) is at a distance from the first through hole (20) or the second through hole (22).

As a result, an improved attachment of a label to a product, such as a wire coil or a bundle of reinforcing bars, can be provided. Thanks to the fact that at least one projecting leg of the spring clip has an outer end intended to extend through said first through hole or said second through hole in the label when the spring clip is attached to the product and the label, a secure attachment of a label is provided that avoid that the label may come loose from its attachment to the product.

Yet further, as a result, the fact is that at least one projecting leg of the spring clip prevents rotation of the key ring around said wire or strap, as the leg cannot pass the limited space between the wire or strap and the product itself when the spring clip is attached to the product. A secure attachment of a label is provided that avoid that the label may come loose from its attachment to the product.

A further advantage is that the spring clip is easy to handle and can be quickly attached to labels to products such as reinforcing bars or wire coils. Further, an efficient and inexpensive spring clip for attachment to products, that in addition can be efficiently produced, is provided.

According to an aspect of the invention, the base portion is ring-formed, comprising a wire thread providing a ring with at least one lap by the wire thread. Preferably, the ring is provided with at least one and a half laps by the wire thread, or preferably at least two laps by the wire thread. According to other possible embodiments of the present invention, the ring may be provided with preferably three or four laps or more than four laps. These aspects improve further the prevented rotation of the key ring around said wire or strap of the spring clip, which also improves the secure attachment to the label.

According to an aspect of the invention, the base portion is ring-formed. The terms “ring-formed” and “ring” are intended to mean a component having a closed-loop structure.

According to an aspect of the invention, said base portion is ring-formed with a preferably circular shape. According to possible variants, the base portion may have shapes other than circular for example square, rectangular, elliptic or other closed shapes.

According to an aspect of the invention, the thickness of the wire thread is preferably comprised between about 0,5 mm and about 4 mm.

According to embodiments of the present invention, suitably, the thickness of the wire thread is at least 1,0 mm, preferably at least 1,3 mm, more preferred at least 1,5 mm and most preferred at least 1,7 mm. In further examples of the present invention, the thickness of the wire thread may be around 1,8mm. According to other examples, the thickness of the wire thread may be 3 mm, 3,2 mm and 4 mm. The spring clip can be adapted for different labels and products by adapting the various dimensions of the wire thickness.

According to a further aspect of the invention, the projecting leg is formed by one end of the wire thread that extends tangentially in a direction away from the ring-formed base portion. Suitably, the projecting leg extends tangentially at least a distance corresponding to half the diameter of the ring-formed base portion. The length of the projecting leg of the spring clip is essential to provide a sufficient, but not too strong, pressure to the attachment to circumferential edges in the through hole at the label.

According to yet a further aspect of the invention, the projecting leg extends through said first hole or second hole in the label with at least half the length of the projecting leg. This provides that secure attachment to the label in order to avoid the label to disengage from the projecting leg.

According to yet a further aspect of the invention, the base portion may have a diameter preferably comprised between about 30 mm and about 90 mm.

According to yet a further aspect of the invention, the base portion, which suitably is ring-formed, has a diameter of at least 30 mm, preferably at least 40 mm, more preferred at least 50 mm. In further examples of the present invention, the base portion has a diameter comprised between about 55 mm and 65 mm. The provided effect is that a suitable secure attachment for the spring clip can be achieved, that is easy to handle, as well as quickly and uncomplicated to attached or detached to a label.

According to yet another aspect of the invention, the ring-formed base portion is provided with a ring with one lap of the wire thread whereafter the wire thread is arranged to extend through the ring-formed base portion. Preferably, the ring-formed base portion is provided with a ring with two laps adjacent each other of the wire thread at one side of the ring-formed base portion whereafter the wire thread is arranged to extend through the ring-formed base portion at the other side of the ring-formed base portion. The provided effect is that a suitable secure attachment for the spring clip can be achieved, that is easy to handle, as well as quick and uncomplicated to attached or detached to a label.

According to a further aspect of the invention, the objects are also reached with a method for attaching a label to a product, such as a wire coil or bundles of bars, by a safety lock spring clip, according to the invention as described above and defined in the claims.

The method provides to wound a wire thread around both said at least one binding element and at least one through hole of the label to define both the base portion and the at least one projecting leg through said through hole in a position such that the projecting leg is pushed against a circumferential edge of the through hole.

Thanks to the fact that at least one projecting leg of the spring clip has an outer end intended to extend through said first through hole or said second through hole in the label when the spring clip is attached to the product and the label, a method for secure attachment of a label is provided that avoid that the label may disengage from its attachment to the product. A further advantage in the method is that the spring clip is easy to handle and can be quickly attached to labels to products such as bars or wire coils. Further, an efficient and inexpensive method for spring clip for attachment to products, that in addition can be efficiently produced, is provided.

According to yet a further aspect of the invention, a use of a safety lock spring clip according to any of claims 1-10 for providing a label to a product, such as a wire coil or bundles of bars is provided.

According to the present invention, it is provided a labelling system which comprises a label having at least one through hole provided with a circumferential edge, and a safety lock spring clip attached to said label and attachable to a product such as bars or wire coils.

The spring clip comprises a base portion, arranged to a first through hole and/or a second through hole in the label, and at least one elongated projecting leg extending tangentially from the base portion

The at least one projecting leg has an outer end extended through said first through hole or said second through hole in the label when the spring clip is attached to the product and the label, the at least one projecting leg is arranged laterally relative the base portion, wherein the leg has an extension tangentially projected through the first through hole or the second through hole in the label such that the outer end is at a distance from the first through hole or the second through hole. The projecting leg is pushed against the circumferential edge of the through hole.

According to an aspect of the invention, the labelling system may also comprise at least one binding element, such as a wire or strap, woundable around said product wherein said base portion develops around said at least one binding element and wherein the label is positioned between said binding element and said at least one projecting leg with limited movement capability.

Further advantages and advantageous features of the invention are disclosed in the following description and in the dependent claims.

### BRIEF DESCRIPTION OF THE DRAWINGS

Below, embodiments of the invention will be described with reference to the drawings, in which:

FIG. 1 shows in a perspective view a safety lock spring clip attached to a label, according to an embodiment of the invention;

FIG. 2 illustrates the ring-formed base portion provided with a ring with one lap of the wire thread, according to another embodiment of the invention;

FIGS. 2a, 2b illustrate another embodiment of the safety lock spring clip according to the invention;

FIGS. 3a, 3b and 3c illustrate a label having through holes with different sizes, in particular the label of FIG. 3c shows a single through hole, and

FIG. 4 shows in a perspective view a safety lock spring clip attached to a label and to a wire coil, according to an embodiment of the invention.

### DETAILED DESCRIPTION OF EMBODIMENTS OF THE INVENTION

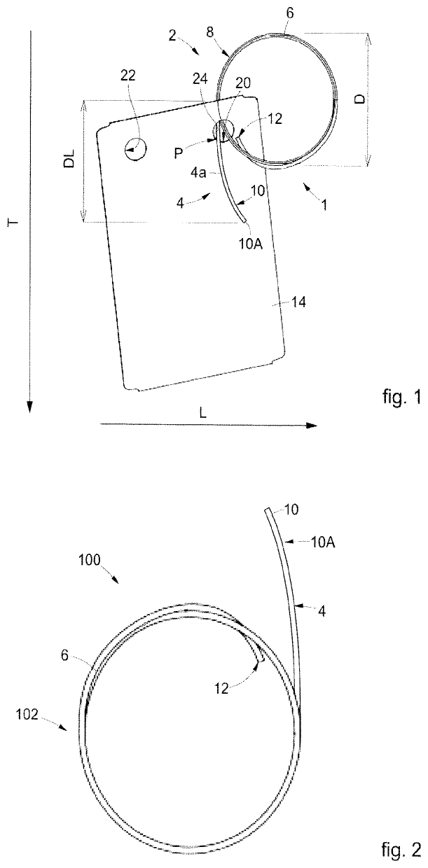

FIG. 1 shows a safety lock spring clip 1 comprising a base portion 2 and at least one projecting leg 4 extending from the base portion 2. The base portion 2 is preferably ring-formed, made of a wire thread 6 forming a ring 8 with at least one lap by the wire thread 6. The ring-formed base portion 2 in FIG. 1 illustrates a ring 8 with about two laps of wire thread 6, even though the ring 8 may have three, four or more than four laps. The at least one projecting leg 4, that extends from the ring 8, is formed by one end 10 of the wire thread 6 that is leaving the ring-formed laps. Preferably, the ring 8 is provided with at least one and a half laps by the wire thread 6. More preferred, the ring 8 is provided with at least two laps by the wire thread 6. The at least one projecting leg 4 has a first outer end 10A formed by the wire thread 6 that is positioned at a distance from the ring-formed base portion 2. The at least one projecting leg 4, also referred to as a first projecting leg 4A, can be arranged laterally L and preferably extending tangentially T relative the ring-formed base portion 2. A second end 12 of the wire thread 6 is preferably arranged within the ring-formed base portion 2. However, the second end 12 can be forming a second projecting leg configured to be arranged laterally L and extending tangentially T relative the ring-formed base portion 2, similar to the first projecting leg 4.

The projecting leg 4 has an elongated shape.

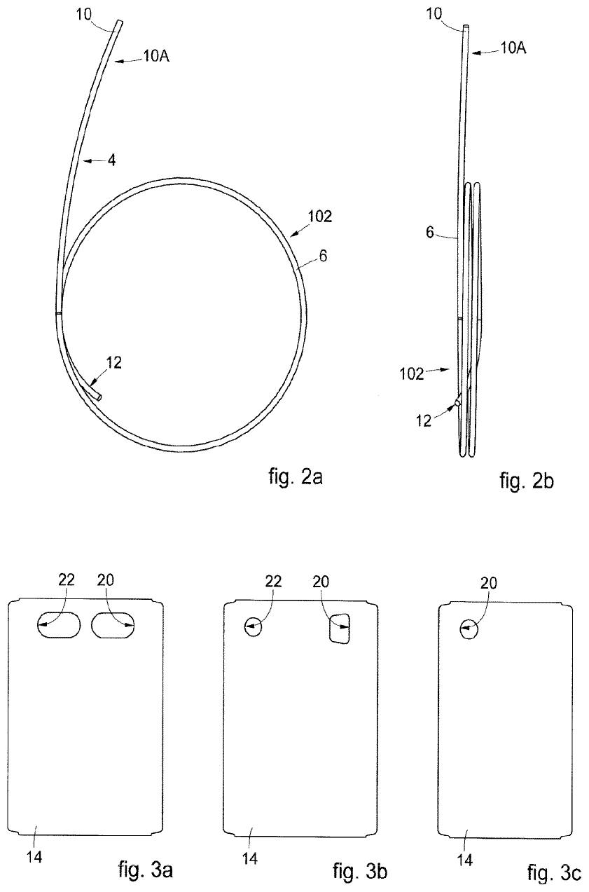

According to embodiments, ss shown in FIGS. 1 and 2, the projecting leg 4 may have a curved elongated shape with a bigger, i.e. significally different, radius of curvature than to the radius of the ring 8.

According to further examples not shown in the drawings, the elongated shape of the projecting leg 4 may be linear.

The first outer end 10a is a free end, i.e. is not attached, or is not attachable, to a product or to binding elements wound around the product.

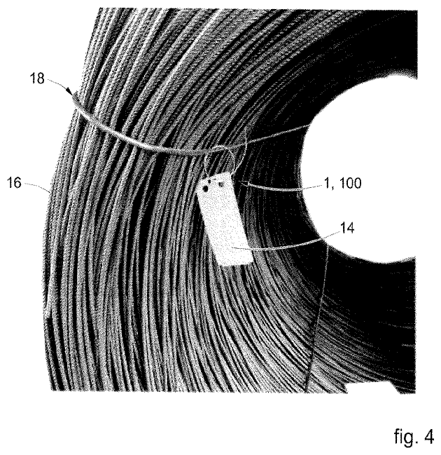

The safety lock spring clip 1 is intended for attaching a label 14 to a product, such as a wire coil 16 as shown in FIG. 4. The laps of wire in the wire coil 16 is usually held together by another wire, a bonding element or wire 18, as illustrated in FIG. 4. The safety lock spring clip 1 may also be used for attaching a label 14 to other products, such as bundles of bars. The bundle of bars is kept together by a bonding wire 18, steel strap or the similar arranged around the bundle for easy handling and transport.

A label 14 for use with the present invention may be of various size, from

relatively small labels 14 having a length and width of about 50×50 mm up to larger labels 14 of about 300×150 mm. Preferably a label 14 used with the present invention can be about 200×110 mm. In further examples, the labels may have a length and width greater than 300×150 mm. The thickness of the labels 14 are relatively thin, from about 0,1mm up to about 6 mm, for example between about 0,2 mm up to about 2 mm.

The label 14 for use with the present invention should be provided with at least one through hole 20. The base portion 2 of the spring clip 1 can be arranged to a first through hole 20 and/or a second through hole 22 in the label 14. Although that the embodiment of arranging the base portion 2 to both the first through hole 20 and the second through hole 22 in the label 14 is not shown in FIG. 1, it is a preferable option for certain applications in which the label can be fixed and arranged in a specific way on the product.

The at least one projecting leg 4 extending from the base portion 2 of the spring clip 1 is intended for arrangement to the first through hole 20 or the second through hole 22 in the label 14. The through hole 20 and the second through hole 22 of the label 14 according to the present invention is suitably in the range from about a length of 30 mm to 80 mm, for example from about 30 mm to about 50 mm and a width of 10 mm to 20 mm. Yet further, a multiple of through holes can be provided in the label 14 with the same dimensions and function as the above described first and second through holes 20, 22.

According to embodiments of the present invention, the through holes 20, 22 may have different shapes, e.g. circular, elliptic, polygonal like square, rectangular, trapezoidal, and also different sizes, FIGS. 3a-3c.

When the base portion 2 is arranged to both the first through hole 20 and the second through hole 22 in the label 14, the through hole 20, 22 of first insertion of the wire thread may have a smaller size than the other through hole 22, 20, FIG. 3b. In fact, the wire thread is better guided at the beginning (first through hole), while in the following passage through the second through hole there is a risk to collide against the wall of the label because the curvature is not controlled anymore.

The at least one projecting leg 4 has an end intended to extend through said first through hole 20 or the second through hole 22 in the label 14 when the spring clip 1 is attached to the product and the label 14. Further, the leg 4 may be pushed by the spring force to press P against a circumferential edge 24 of the through hole 20. However, the fact is that at least one projecting leg of the spring clip prevents rotation of the key ring around said wire or strap, as the leg cannot pass the limited space between the wire or strap and the product itself when the spring clip is attached to the product. A secure attachment of a label is provided that avoid that the label may come loose from its attachment to the product.

The thickness of the wire thread is preferably comprised between about 0,5 mm and about 4 mm.

The thickness of the wire thread 6 for the safety lock spring clip 1, according to embodiments of the invention, is suitably in the range equal to or not less than about 1,0 mm and up to or equal to not more than about 3,0 mm, preferably equal to or not less than about 1,3 mm and up to or equal to not more than about 2,8 mm, more preferred equal to or not less than about 1,5 mm and up to or equal to not more than about 2,6 mm, and most preferred equal to or not less than about 1,7 mm and up to or equal to not more than about 2,4 mm.

Typically, the base portion 2 may have a diameter D preferably comprised between about 30 mm and about 90 mm.

According to possible embodiments, the diameter D of the base portion 2 is suitably in the range equal to or not less than about 30 mm and, in some cases, up to or equal to not more than about 100 mm, preferably equal to or not less than about 40 mm and up to or equal to not more than about 90 mm, and more preferred equal to or not less than about 50 mm and up to or equal to not more than about 80 mm.

According to a further aspect of the invention, the projecting leg 4 extends tangentially T at least a length DL corresponding to half the diameter D of the ring-formed base portion 2. Further, the projecting leg 4 extends through said first through hole 20 or said second through hole 22 in the label 14 with at least half the length DL of the projecting leg 4.

FIG. 2 shows a safety lock spring clip 100 according to another embodiment of the invention. The same reference numerals are used for the corresponding features as shown and described with reference to FIG. 1. As shown in FIG. 2, a ring-formed base portion 102 is provided with a ring with one lap of the wire thread 6 whereafter the wire thread 6 is arranged to extend through the ring-formed base portion 102. Further, according to yet another embodiment (shown in FIGS. 2a, 2b), the ring-formed base portion 102 is provided with a ring with two laps adjacent each other of the wire thread 6 at one side of the ring-formed base portion 102 whereafter the wire thread 6 is arranged to extend through the ring-formed base 102 at the other side of the ring-formed base portion 102, FIG. 2b.

The present invention also involves steps in a method for attaching a label 14 to a product, such as a wire coil 16 or bundles of bars, by a safety lock spring clip 1 as described above with reference to FIG. 1 and FIG. 4. Hence, the method involves providing the safety lock spring clip 1 with a label 14, such that the end 10A of the projecting leg extend through the first through hole 20 or the second through hole 22 in the label 14 such that the outer end 10A is at a distance from the first through hole 20 or the second through hole 22, and attaching the safety lock spring clip 1 to the product. The method is preferably performed by a tool configured to feed the wire thread 6 through the first through hole 20 and/or the second through hole 22 in the label 14,

The present invention also involves an action of use of a safety lock spring clip 1 according to any of claims 1-10 and as described above with reference to FIGS. 1-4, for providing a label 14 to a product, such as a wire coil 16 or bundles of bars.

It is to be understood that the present invention is not limited to the embodiments described above and illustrated in the drawings; rather, the skilled person will recognize that many changes and modifications may be made within the scope of the appended claims.

1-14. (canceled)

15. A combination of a safety lock spring clip, intended for attaching a label, having at least one through hole, to a product such as a wire coil or a bundle of bars around which a binding element such as a wire or strap is wrapped, and a label, the spring clip comprising a base portion, arrangeable to a first through hole and/or a second through hole in the label, and at least one elongated projecting leg extending tangentially in a direction away from the base portion, wherein the at least one projecting leg has an outer end extendable through said first through hole or said second through hole in the label when the spring clip is attached to the product and the label, wherein the projecting leg is extendable through said first through hole or said second through hole in the label with at least half the length of the projecting leg, the at least one projecting leg is arranged laterally relative the base portion, wherein the leg has an extension tangentially projectable through the first through hole or the second through hole in the label such that the outer end is at a distance from the first through hole or the second through hole, wherein the base portion and the projecting leg are formed by a wire thread woundable around both said binding element and one through hole of the label, wherein the projecting leg is pushed against a circumferential edge of the through hole, wherein said label is positioned between said binding element and said at least one projecting leg with limited movement capability.

16. The combination of a safety lock spring clip and a label according to claim 15, wherein the base portion is ring-formed, comprising a wire thread providing a ring with at least one lap by the wire thread.

17. The combination of a safety lock spring clip and a label according to claim 16, wherein the ring is provided with at least one and a half laps by the wire thread.

18. The combination of a safety lock spring clip and a label according to claim 16, wherein the thickness of the wire thread is comprised between 0.5 mm and 4 mm.

19. The combination of a safety lock spring clip and a label according to claim 16, wherein the projecting leg is formed by one end of the wire thread that extends tangentially in a direction away from the ring-formed base portion.

20. The combination of a safety lock spring clip and a label according to claim 19, wherein the projecting leg extends tangentially at least a distance corresponding to half the diameter of the ring-formed base portion.

21. The combination of a safety lock spring clip and a label according to claim 15, wherein the base portion has a diameter comprised between 30 mm and 90 mm.

22. The combination of a safety lock spring clip and a label according to claim 16, wherein the ring-formed base portion is provided with a ring with one lap of the wire thread whereafter the wire thread is arranged to extend through the ring-formed base portion.

23. The combination of a safety lock spring clip and a label according to claim 16, wherein the ring-formed base portion is provided with a ring with two laps adjacent each other of the wire thread at one side of the ring-formed base portion whereafter the wire thread is arranged to extend through the ring-formed base portion at the other side of the ring-formed base portion.

24. A labelling system comprising:
a label having at least one through hole provided with a circumferential edge;
a safety lock spring clip attached to said label and attachable to a product;
a binding element woundable around said product;
the spring clip comprising a base portion, arranged to a first through hole and/or a second through hole in the label, and at least one elongated projecting leg extending tangentially from the base portion, wherein the at least one projecting leg has an outer end extended through said first through hole or said second through hole in the label when the spring clip is attached to the product and the label, wherein the projecting leg is extendable through said first through hole or said second through hole in the label with at least half the length of the projecting leg, the at least one projecting leg is arranged laterally relative the base portion, wherein the leg has an extension tangentially projected through the first through hole or the second through hole in the label such that the outer end is at a distance from the first through hole or the second through hole, wherein the label is positioned between said binding element and said at least one projecting leg with limited movement capacity, wherein the projecting leg is pushed against the circumferential edge of the through hole, wherein the projecting leg extends tangentially at least a distance corresponding to half the diameter of the ring-formed base portion.

25. The labelling system according to claim 24, wherein said base portion develops around said at least one binding element and wherein the label is positioned between said binding element and said at least one projecting leg with limited movement capability.

26. A method for attaching a label to a product, such as a wire coil or bundles of bars consolidated by at least one binding element, by a safety lock spring clip according to any of claim 1, wherein the method comprising winding a wire thread around both said at least one binding element and at least one through hole of the label to define both the base portion and the at least one projecting leg through said through hole in a position such that the projecting leg is pushed against a circumferential edge of the through hole.

27. The use of a safety lock spring clip according to claim 1 for providing a label to a product, such as a wire coil or bundles of bars.
